(19) United States
(12) Patent Application Publication
(10) Pub. No.: US 2025/0192301 A1
(43) Pub. Date: Jun. 12, 2025

(54) THERMAL BARRIER BULB SEALS FOR ESTABLISHING SEALING INTERFACES WITHIN TRACTION BATTERY PACKS

(71) Applicant: FORD GLOBAL TECHNOLOGIES, LLC, Dearborn, MI (US)

(72) Inventors: Jordyn Cobbs, Detroit, MI (US); Mohammadreza Eftekhari, Novi, MI (US); Kanchana Perumalla, Troy, MI (US); Patrick Roxin, Livonia, MI (US)

(21) Appl. No.: 18/781,044

(22) Filed: Jul. 23, 2024

Related U.S. Application Data
(60) Provisional application No. 63/607,888, filed on Dec. 8, 2023.

(51) Int. Cl. H01M 50/24; B60L 50/64; H01M 10/658; H01M 50/211; H01M 50/289

(52) U.S. Cl. CPC H01M 50/24; B60L 50/64; H01M 10/658; H01M 50/211; H01M 50/289; H01M 2220/20

(57) ABSTRACT

Battery cell stack designs are provided for traction battery packs. An exemplary cell stack may include a thermal barrier assembly that is arranged to inhibit the transfer of thermal energy between adjacent subgroupings of battery cells of the cell stack. The thermal barrier assembly may include a bulb seal for sealing an interface between the thermal barrier assembly and a perimeter environment (e.g., a heat exchanger plate, an enclosure tray, etc.). The bulb seal may seal any leak paths between the thermal barrier assembly and the perimeter environment, thereby preventing vent gases from passing from one battery cell subgrouping to another during battery thermal events.

### CROSS-REFERENCE TO RELATED APPLICATIONS

This disclosure claims priority to U.S. Provisional Application No. 63/607,888, which was filed on Dec. 8, 2023 and is incorporated herein by reference in its entirety.

### TECHNICAL FIELD

This disclosure relates generally to traction battery packs, and more particularly to a thermal barrier bulb seal for sealing an interface between a thermal barrier assembly and a perimeter environment within a traction battery pack.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, a battery cell stack, an enclosure structure establishing a perimeter environment to the battery cell stack, a thermal barrier assembly of the battery cell stack arranged to partition the battery cell stack into a first compartment and a second compartment, and a bulb seal secured to a structural barrier of the thermal barrier assembly and configured to seal an interface between the thermal barrier assembly and the enclosure structure.

In a further non-limiting embodiment of the foregoing traction battery pack, the bulb seal is secured to a bottom edge of a lower interfacing structure of the structural barrier.

In a further non-limiting embodiment of either of the foregoing traction battery packs, the bulb seal is secured to a protruding barb of the bottom edge of the lower interfacing structure of the structural barrier.

In a further non-limiting embodiment of any of the foregoing traction battery packs, the enclosure structure is part of a heat exchanger plate.

In a further non-limiting embodiment of any of the foregoing traction battery packs, the enclosure structure is part of an enclosure tray of an enclosure assembly of the traction battery pack.

In a further non-limiting embodiment of any of the foregoing traction battery packs, the structural barrier includes an upper interfacing structure that interfaces with an enclosure cover of the enclosure assembly.

In a further non-limiting embodiment of any of the foregoing traction battery packs, the bulb seal includes a base portion that interfaces with the structural barrier and a dome-like portion that interfaces with an exterior surface of the enclosure structure.

In a further non-limiting embodiment of any of the foregoing traction battery packs, the base portion straddles a protruding barb of a bottom edge of a lower interfacing structure of the structural barrier.

In a further non-limiting embodiment of any of the foregoing traction battery packs, the base portion includes projecting legs that flank the protruding barb.

In a further non-limiting embodiment of any of the foregoing traction battery packs, the bulb seal includes opposing end portions that each include a pair of tongues.

In a further non-limiting embodiment of any of the foregoing traction battery packs, the pair of tongues is configured to seal a transition region at an exterior surface of the enclosure structure.

In a further non-limiting embodiment of any of the foregoing traction battery packs, the transition region is located at a section of the exterior surface that includes an undulation.

In a further non-limiting embodiment of any of the foregoing traction battery packs, the structural barrier includes a pultrusion.

A traction battery pack according to another exemplary aspect of the present disclosure includes, among other things, an upper enclosure structure, a lower enclosure structure, a first grouping of battery cells and a second grouping of battery cells arranged to extend between the upper enclosure structure and the lower enclosure structure, and a thermal barrier assembly positioned to separate the first grouping of battery cells from the second grouping of battery cells. The thermal barrier assembly includes a structural barrier and a bulb seal secured to the structural barrier. The bulb seal is configured to seal a first interface between the thermal barrier assembly and the lower enclosure structure.

In a further non-limiting embodiment of the foregoing traction battery pack, an adhesive is configured to seal a second interface between the thermal barrier assembly and the upper enclosure structure.

In a further non-limiting embodiment of either of the foregoing traction battery packs, the bulb seal is secured to a protruding barb of a bottom edge of a lower interfacing structure of the structural barrier.

In a further non-limiting embodiment of any of the foregoing traction battery packs, the bulb seal includes a base portion that interfaces with the structural barrier and a dome-like portion that interfaces with an exterior surface of the lower enclosure structure.

In a further non-limiting embodiment of any of the foregoing traction battery packs, the base portion straddles a protruding barb of a bottom edge of a lower interfacing structure of the structural barrier.

In a further non-limiting embodiment of any of the foregoing traction battery packs, the bulb seal includes opposing end portions that each include a pair of tongues.

In a further non-limiting embodiment of any of the foregoing traction battery packs, each tongue of the pair of tongues is configured to seal a transition region at an exterior surface of the lower enclosure structure.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is an exploded perspective view of a traction battery pack for an electrified vehicle.

FIG. 3 illustrates select portions of an exemplary cell stack of the traction battery pack of FIG. 2.

FIG. 4 illustrates an exemplary bulb seal for sealing an interface between a thermal barrier assembly and a perimeter environment of a traction battery pack.

FIGS. 5, 6, and 7 illustrate another exemplary bulb seal for sealing an interface between a thermal barrier assembly and a perimeter environment of a traction battery pack.

### DETAILED DESCRIPTION

This disclosure details battery cell stack designs for traction battery packs. An exemplary cell stack may include a thermal barrier assembly that is arranged to inhibit the transfer of thermal energy between adjacent subgroupings of battery cells of the cell stack. The thermal barrier assembly may include a bulb seal for sealing an interface between the thermal barrier assembly and a perimeter environment (e.g., a heat exchanger plate, an enclosure tray, etc.). The bulb seal may seal any leak paths between the thermal barrier assembly and the perimeter environment, thereby preventing vent gases from passing from one battery cell subgrouping to another during battery thermal events. These and other features are discussed in greater detail in the following paragraphs of this detailed description.

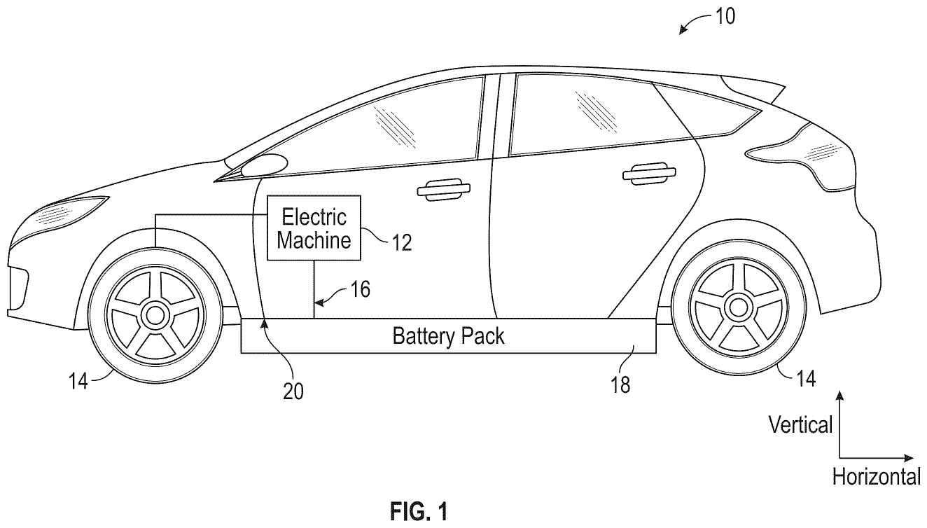

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

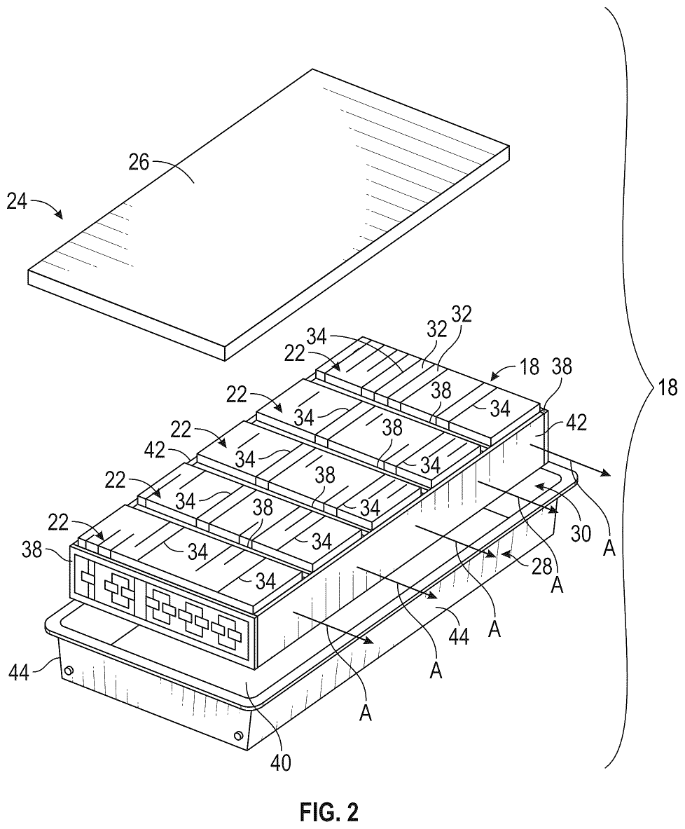

FIG. 2 illustrates additional details associated with the traction battery pack 18 of the electrified vehicle 10 of FIG. 1. The traction battery pack 18 may include a plurality of cell stacks 22 housed within an interior area 30 of an enclosure assembly 24. The enclosure assembly 24 of the traction battery pack 18 may include an enclosure cover 26 and an enclosure tray 28. The enclosure cover 26 may be secured (e.g., bolted, welded, adhered, etc.) to the enclosure tray 28 to provide the interior area 30 for housing the cell stacks 22 and other battery internal components of the traction battery pack 18.

Each cell stack 22 may include a plurality of battery cells 32. The battery cells 32 of each cell stack 22 may be stacked together and arranged along a cell stack axis A. The battery cells 32 store and supply electrical power for powering various components of the electrified vehicle 10. Although a specific number of cell stacks 22 and battery cells 32 are illustrated in the various figures of this disclosure, the traction battery pack 18 could include any number of the cell stacks 22, with each cell stack 22 including any number of individual battery cells 32.

In an embodiment, the battery cells 32 are lithium-ion pouch cells. However, battery cells having other geometries (cylindrical, prismatic, etc.) and/or chemistries (nickel-metal hydride, lead-acid, etc.) could alternatively be utilized within the scope of this disclosure. The battery cells 32 can each include tab terminals that project outwardly from a battery cell housing. The tab terminals of the battery cells 32 of each cell stack 22 are connected to one another, such as by one or more busbars, for example, in order to provide the voltage and power levels necessary for achieving electric vehicle propulsion.

One or more thermal barrier assemblies 34 may be arranged along the respective cell stack axis A of each cell stack 22. The thermal barrier assemblies 34 may compartmentalize each cell stack 22 into two or more groupings or compartments.

The battery cells 32 and the thermal barrier assemblies 34 of each cell stack 22 may be arranged to extend between a pair of cross-member assemblies 38. Among other functions, the cross-member assemblies 38 may be configured to hold the battery cells 32 and at least partially delineate the cell stacks 22 from one another within the interior area 30 of the enclosure assembly 24.

Each cross-member assembly 38 may be configured to transfer a load applied to a side of the electrified vehicle 10, for example, for ensuring that the battery cells 32 do not become overcompressed. Each cross-member assembly 38 may be further configured to accommodate tension loads resulting from expansion and retraction of the battery cells 32. The cross-member assemblies 38 are therefore configured to increase the structural integrity of the traction battery pack 18.

A vertically upper side of each cell stack 22 may interface with the enclosure cover 26, and a vertically lower side of each cell stack 22 may interface with a heat exchanger plate 40 that is positioned against a floor of the enclosure tray 28. In another embodiment, the heat exchanger plate 40 may be omitted and the vertically lower side of each cell stack 22 may be received in direct contact with the floor of the enclosure tray 28. Vertical and horizontal, for purposes of this disclosure, are with reference to ground and a general orientation of traction battery pack 18 when installed within the electrified vehicle 10 of FIG. 1.

The cross-member assemblies 38 may be adhesively secured to the enclosure cover 26 and to either the heat exchanger plate 40 or the enclosure tray 28 to seal the interfaces between these neighboring components and to structurally integrate the traction battery pack 18.

The cell stacks 22 may be arranged to extend along their respective cell stack axes A between opposing end plates 42. One or more end plates 42 may be positioned between each end of each cell stack 22 and a longitudinally extending side wall 44 of the enclosure tray 28. The end plates 42 may therefore extend along axes that are substantially transverse (e.g. perpendicular) to the cell stack axes A of the cell stacks 22 and to the cross-member assemblies 38. In some implementations, the end plates 42 are structural megabar members that span across a majority of the length of the longitudinally extending side wall 44 of the enclosure tray 28. However, other configurations are contemplated within the scope of this disclosure.

In an embodiment, the cell stacks 22 and the cross-member assemblies 38 extend longitudinally in a cross-vehicle direction of the electrified vehicle 10, and the end plates 42 extend longitudinally in a length-wise direction of the electrified vehicle 10. However, other configurations are contemplated within the scope of this disclosure.

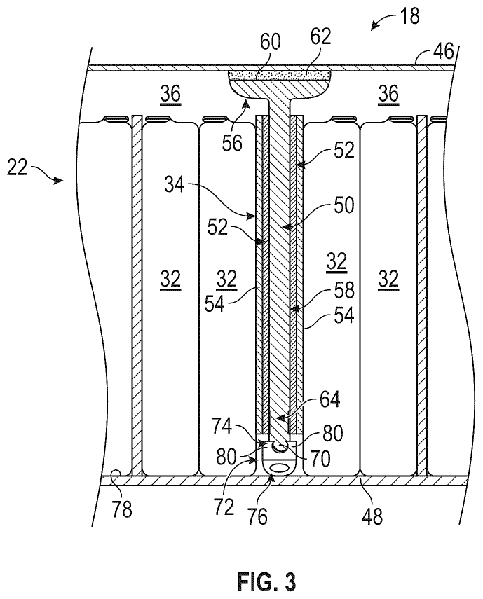

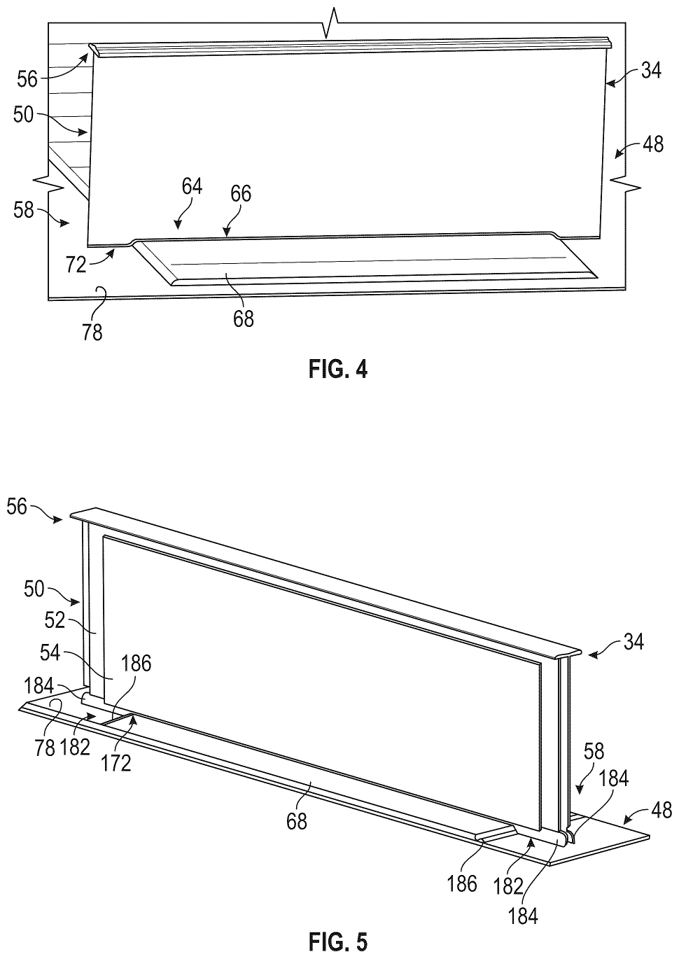

Referring now to FIGS. 3-4, with continued reference to FIGS. 1-2, one or more thermal barrier assemblies 34 may be arranged along the respective cell stack axis A of each cell stack 22. The thermal barrier assemblies 34 may compartmentalize each cell stack 22 into two or more subgroupings or compartments 36 of battery cells 32. Each compartment 36 may hold one or more of the battery cells 32 of the cell stack 22.

Should, for example, a battery thermal event occur in one of the cell stacks 22, the thermal barrier assemblies 34 may reduce or even prevent thermal energy associated with the thermal event from moving from cell-to-cell, compartment-to-compartment, and/or cell stack-to-cell stack, thereby inhibiting the transfer of thermal energy inside the traction battery pack 18. As further explained below, the thermal barrier assemblies 34 may be further configured to seal an interface between each thermal barrier assembly 34 and its perimeter environment (e.g., the heat exchanger plate 40 or the enclosure tray 28).

Each thermal barrier assembly 34 of the cell stack 22 may include a structural barrier 50 that is flanked by pairs of thermal resistance material layers 52 and foam layers 54 as part of a multi-layered structure of the thermal barrier assembly 34. In the illustrated embodiment, the structural barrier 50 may be sandwiched between the thermal resistance material layers 52, and the foam layers 54 may be positioned outboard of the foam layers 54. The foam layers 54 may thus flank the thermal resistance material layers 52 and can be positioned in abutting contact with major side surfaces of battery cells 32 located in adjacent compartments 36 of the cell stack 22.

The structural barrier 50 may include a thermoplastic structure or a polymer composite structure (e.g., glass fiber reinforced polypropylene with an intumescent additive), for example, the thermal resistance material layers 52 may include aerogel layers or mica sheets, for example, and the foam layers 54 may include polyurethane foam or silicone foam, for example. However, other materials or combinations of materials could be utilized to construct the subcomponents of the thermal barrier assembly 34 within the scope of this disclosure.

As will be appreciated by persons of ordinary skill in the art having the benefit of this disclosure, the exemplary thermal barrier assemblies 34 shown in the various figures of this disclosure are not necessarily drawn to scale. Certain aspects of each thermal barrier assembly 34 have been exaggerated to better illustrate substituent components and their arrangement relative to one another.

The structural barrier 50 of the thermal barrier assembly 34 may be a pultrusion, which implicates structure to this component. A person of ordinary skill in the art having the benefit of this disclosure would understand how to structurally distinguish a pultruded structure from another type of structure, such as an extrusion, for example. The structural barrier 50 may be manufactured as part of a pultrusion process that utilizes a glass or carbon fiber (unidirectional or multidirectional mat) and a thermoset resin. A plurality of glass or carbon fiber strands may be pulled through the thermoset resin as part of the pultrusion process for manufacturing the structural barrier 50. In other implementations, the structural barrier 50 could be an injection molded part or an extruded part.

Each thermal barrier assembly 34 may be configured to establish a sealed interface at both an upper enclosure structure 46 and a lower enclosure structure 48 of the traction battery pack 18. The upper enclosure structure 46 may be part of the enclosure cover 26 of the enclosure assembly 24 or could be an intermediate structure (e.g., an actively cooled heat exchanger plate) that is positioned between the thermal barrier assembly 34 and the enclosure cover 26. The lower enclosure structure 48 may be part of the actively cooled heat exchanger plate 40 that is positioned between the structural thermal barrier assembly 34 and the enclosure tray 28, or could alternatively be part of the enclosure tray 28.

The structural barrier 50 of the thermal barrier assembly 34 may include an upper interfacing structure 56 that is configured to interface with the upper enclosure structure 46, and a lower interfacing structure 58 that is configured to interface with lower enclosure structure 48. Together, the upper interfacing structure 56 and the lower interfacing structure 58 may establish a T-shaped cross-section of the structural barrier 50. However, other shapes are contemplated within the scope of this disclosure.

The upper interfacing structure 56 may provide an upper plateau 60 for securing the thermal barrier assembly 34 to the upper enclosure structure 46, such as via an adhesive 62, for example. The adhesive 62 may be an epoxy based adhesive or a urethane based adhesive, for example. Once the upper interfacing structure 56 is secured relative to the upper enclosure structure 46, the thermal barrier assembly 34 can substantially prevent thermal energy from moving from one compartment 36 to another at the sealed interface between the thermal barrier assembly 34 and the upper enclosure structure 46, such as during a battery thermal event, for example.

The lower interfacing structure 58 may be disposed on an opposite end of the structural barrier 50 from the upper interfacing structure 56. The lower interfacing structure 58 may include a bottom edge 64. The bottom edge 64 may include a notched section 66 (best seen in FIG. 4). The notched section 66 may be configured for accommodating a contour of the lower enclosure structure 48. For example, the notched section 66 may accommodate an undulation 68 (see FIG. 4) of the lower enclosure structure 48.

The bottom edge 64 of the lower interfacing structure 58 of the structural barrier 50 may additionally include a protruding barb 70. The protruding barb 70 may extend vertically in a direction toward the lower enclosure structure 48.

A bulb seal 72 may be secured to the protruding barb 70 of the bottom edge 64 for sealing an interface between the thermal barrier assembly 34 and the lower enclosure structure 48. The bulb seal 72 may be arranged to seal any leak paths between the thermal barrier assembly 34 and the lower enclosure structure 48. Accordingly, in the event of a battery thermal event in which one or more of the battery cells 32 of the cell stack 22 can release vent gases, the bulb seal 72 is configured to prevent the vent gases from passing from one compartment 36 to another at the interface between thermal barrier assembly 34 and the lower enclosure structure 48.

In an embodiment, the bulb seal 72 is made of a compressible material, such as rubber or a silicone-based material, for example. In another embodiment, the bulb seal 72 is an extruded part. However, other compressible materials or combinations of materials and/or manufacturing techniques are contemplated within the scope of this disclosure.

The bulb seal 72 may include a base portion 74 and a dome-like portion 76 that extends from the base portion 74. The base portion 74 may be configured to interface with the bottom edge 64 of the lower interfacing structure 58 of the structural barrier 50, and the dome-like portion 76 may be configured to interface with an exterior surface 78 of the lower enclosure structure 48 for sealing the interface therebetween.

The base portion 74 of the bulb seal 72 may be arranged to straddle the protruding barb 70 of the bottom edge 64 of the lower interfacing structure 58. For example, projecting legs 80 of the base portion 74 may flank the protruding barb 70 when the bulb seal 72 is secured to the structural barrier 50 of the thermal barrier assembly 34.

The dome-like portion 76 of the bulb seal 72 may be at least partially hollow and may flex or compress when positioned in contact with the exterior surface 78 of the lower enclosure structure 48. The bulb seal 72 may therefore accommodate for dimensional variations of the lower enclosure structure 48 and maintain an adequate seal between the thermal barrier assembly 34 and the lower enclosure structure 48.

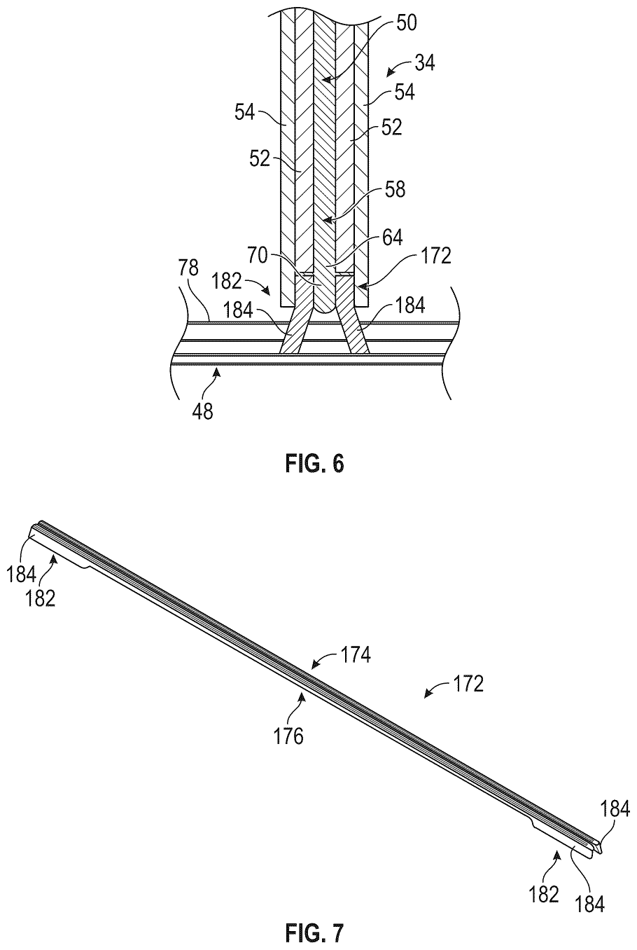

FIGS. 5, 6, and 7 illustrate another exemplary bulb seal 172 that can be provided for sealing an interface between the thermal barrier assembly 34 and the lower enclosure structure 48. The bulb seal 172 is similar to the bulb seal 72 described above and thus may include a base portion 174 and a dome-like portion 76 that function as described above. However, in this embodiment, each opposing end portion 182 of the bulb seal 172 may include a pair of tongues 184. The tongues 184 may be configured for providing an adequate seal at transition regions 186 (see FIG. 5) of the lower enclosure structure 48. The transition regions 186 occur at sections of the exterior surface 78 where the contour of the lower enclosure structure 48 changes due to the undulation 68. In some implementations, the tongues 184 may be further configured to be received within slots or openings formed in the exterior surface 78 of the lower enclosure structure 48 in order to fill the slot/opening and adequately seal the interface.

The exemplary cell stacks of this disclosure include thermal barrier assemblies each having a bulb seal for sealing an interface between the thermal barrier assembly and its perimeter environment. The bulb seals are capable of preventing vent gases from passing between the thermal barrier assembly and the perimeter environment during battery thermal events, thereby providing thermal mitigation benefits compared to known battery cell stack arrangements.

may engage one another at their interfaces for maintaining a cell stack together before future assembly into a full traction battery pack. The compression end plates may tie into the cross-member assemblies via mateable retention features for establishing a cross-member-to-end plate connection and allowing the end plates to apply a compressive load across the cell stack.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a battery cell stack;
an enclosure structure establishing a perimeter environment to the battery cell stack;
a thermal barrier assembly of the battery cell stack arranged to partition the battery cell stack into a first compartment and a second compartment; and
a bulb seal secured to a structural barrier of the thermal barrier assembly and configured to seal an interface between the thermal barrier assembly and the enclosure structure.

2. The traction battery pack as recited in claim 1, wherein the bulb seal is secured to a bottom edge of a lower interfacing structure of the structural barrier.

3. The traction battery pack as recited in claim 2, wherein the bulb seal is secured to a protruding barb of the bottom edge of the lower interfacing structure of the structural barrier.

4. The traction battery pack as recited in claim 3, wherein the enclosure structure is part of a heat exchanger plate.

5. The traction battery pack as recited in claim 3, wherein the enclosure structure is part of an enclosure tray of an enclosure assembly of the traction battery pack.

6. The traction battery pack as recited in claim 5, wherein the structural barrier includes an upper interfacing structure that interfaces with an enclosure cover of the enclosure assembly.

7. The traction battery pack as recited in claim 1, wherein the bulb seal includes a base portion that interfaces with the structural barrier and a dome-like portion that interfaces with an exterior surface of the enclosure structure.

8. The traction battery pack as recited in claim 7, wherein the base portion straddles a protruding barb of a bottom edge of a lower interfacing structure of the structural barrier.

9. The traction battery pack as recited in claim 8, wherein the base portion includes projecting legs that flank the protruding barb.

10. The traction battery pack as recited in claim 1, wherein the bulb seal includes opposing end portions that each include a pair of tongues.

11. The traction battery pack as recited in claim 10, wherein the pair of tongues is configured to seal a transition region at an exterior surface of the enclosure structure.

12. The traction battery pack as recited in claim 11, wherein the transition region is located at a section of the exterior surface that includes an undulation.

13. The traction battery pack as recited in claim 1, wherein the structural barrier includes a pultrusion.

14. A traction battery pack, comprising:
an upper enclosure structure;
a lower enclosure structure;
a first grouping of battery cells and a second grouping of battery cells arranged to extend between the upper enclosure structure and the lower enclosure structure; and
a thermal barrier assembly positioned to separate the first grouping of battery cells from the second grouping of battery cells, the thermal barrier assembly including a structural barrier and a bulb seal secured to the structural barrier,
wherein the bulb seal is configured to seal a first interface between the thermal barrier assembly and the lower enclosure structure.

15. The traction battery pack as recited in claim 14, comprising an adhesive configured to seal a second interface between the thermal barrier assembly and the upper enclosure structure.

16. The traction battery pack as recited in claim 14, wherein the bulb seal is secured to a protruding barb of a bottom edge of a lower interfacing structure of the structural barrier.

17. The traction battery pack as recited in claim 14, wherein the bulb seal includes a base portion that interfaces with the structural barrier and a dome-like portion that interfaces with an exterior surface of the lower enclosure structure.

18. The traction battery pack as recited in claim 17, wherein the base portion straddles a protruding barb of a bottom edge of a lower interfacing structure of the structural barrier.

19. The traction battery pack as recited in claim 14, wherein the bulb seal includes opposing end portions that each include a pair of tongues.

20. The traction battery pack as recited in claim 19, wherein each tongue of the pair of tongues is configured to seal a transition region at an exterior surface of the lower enclosure structure.
